(19) United States
(12) Patent Application Publication
(10) Pub. No.: US 2019/0193903 A1
(43) Pub. Date: Jun. 27, 2019

(54) PACKAGE FOR A FOOD AND A TOPPING

(71) Applicants: Amir Tamshe, Rancho Cucamonga, CA (US); James E Grove, Marina Del Rey, CA (US)

(72) Inventors: Amir Tamshe, Rancho Cucamonga, CA (US); James E Grove, Marina Del Rey, CA (US)

(21) Appl. No.: 15/856,032

(22) Filed: Dec. 27, 2017

(51) Int. Cl. B65D 51/18; B65D 77/20; B65D 85/72; B65D 21/02; A23L 11/00

(52) U.S. Cl. CPC B65D 51/18; B65D 77/2024; B65D 77/2068; B65D 85/72; A23V 2002/00; A23L 11/05; B65D 2251/0018; B65D 2251/005; B65D 2577/205; B65D 21/0222

(57) ABSTRACT

Disclosed is an improved food package that includes a food bowl having an open top and a closed bottom and in which a food (e.g., hummus) and a topping are packaged. A sealing ledge extends inwardly from the food bowl downwardly from and below the open top thereof. A peel-off film that is sealed against the sealing ledge extends laterally across the food bowl above and in close proximity to the food and the topping. The peel-off film closes the food bowl and prevents the food and its topping from spilling out. By virtue of locating the peel-off film below the open top of the food bowl, a relatively low volume airspace is established between the film and the food to prevent a premature mixing of the food and the topping when the food package undergoes a high pressure processing (HPP) treatment.

### BACKGROUND OF THE INVENTION

### 1. Field of the Invention

This invention relates to an improved food package including a food bowl in which a food (e.g., hummus) and a topping are packaged and a lid that is detachably connected to the top of the food bowl to enclose the food therewithin. A peel-off film covers the food below the top of the food bowl such that there is only a small volume airspace between the food and the film. The food package herein disclosed has particular application to be subjected to a high pressure processing (HPP) treatment by which potentially harmful food-borne pathogens and similar organisms are eliminated while a premature mixing of the food and the topping is avoided prior to their being consumed.

### 2. Background Art

It is known to expose packaged food to a conventional high pressure processing (HPP) treatment to eliminate food-borne pathogens and similar organisms. Briefly, the packaged food is held in water under extreme pressure so as to advantageously make the food safe for consumption and extend the refrigerated shelf life thereof. However, the high pressure to which the packaged food is subjected causes the food within the package to experience turbulence prior to its consumption which has, in some circumstances, been known to cause problems for food distributors and consumers alike. By way of one example, hummus is usually sold to consumers in a clear container. A colorful and tasty topping is traditionally added so as to lie on top of the hummus at which to be visible through the container in order to enhance the commercial appeal of the hummus to consumers. When a conventional container is subjected to the high pressure HPP treatment, an unintended consequence of such treatment is that the topping is prematurely mixed with the hummus. Once the hummus reaches the shelf of a retail store, the consumer is able to look through the clear container and see the mixture of hummus and topping which can be visually less appealing to the consumer than had the hummus and its topping remained separate and intact one above the other. Thus, the consumer may not be as inclined to purchase the high pressure HPP treated hummus which could cost both the food distributor and the retailer a sale and may ultimately result in the hummus not being purchased at all.

Our patent application Ser. No. 15/722,415 filed Oct. 2, 2017 describes one example of a food package in which a food, such as hummus, or the like, and a topping can be packaged independently of one another and kept separated during and after the food package is subjected to an HPP treatment to thereby avoid the hummus and its topping from being prematurely mixed together prior to their consumption. In the present case to be disclosed below, a different food package is described that is also capable of solving the problem described above, but without having to separate the topping from the food (e.g., hummus) while the package is subjected to the HPP treatment.

### SUMMARY OF THE INVENTION

In general terms, an improved food package is disclosed including a food bowl that is filled with a food, such as hummus or the like, and a topping that lies atop the hummus to be mixed therewith when the hummus is consumed. The food bowl is preferably manufactured from a visually transparent material that is adapted to withstand a high pressure processing (HPP) treatment by which to eliminate potentially harmful food-borne pathogens and similar organisms in the hummus and the topping with which the food bowl is filled. A peripheral sealing ledge extends inwardly of the food bowl so as to lie below the normally open top thereof. A peel-off film that is sealed to the sealing ledge extends laterally across the food bowl to cover the hummus and close the food bowl to prevent the hummus and topping from spilling out. A visually transparent and flexible lid is detachably connected to the top of the food bowl to enclose the hummus and the topping lying thereon.

The peel-off film that is attached to the sealing ledge below the normally open top of the food bowl is located in close proximity to the hummus and the topping so as to minimize the usual airspace that is traditionally located between the film and the hummus. In particular, it is preferable that the peel-off film which closes the food bowl lie closer to the hummus than to the open top of the food bowl so that the volume of the airspace which extends between the film and the hummus is reduced to 5% to 10% the volume of the airspace that is found in a conventional food bowl where the film is sealed to and extends laterally across the normally open top thereof. By virtue of reducing the volume of the traditional airspace which lies between the film and the hummus, the improved food package can undergo an HPP treatment without the hummus and its topping being subjected to turbulence under pressure and becoming mixed together prior to their consumption before the peel-off film has first been removed from the food bowl.

### BRIEF DESCRIPTION OF THE DRAWINGS

FIG. 1 is an exploded view of an improved food package within which a food and a topping are carried according to a preferred embodiment of this invention;

FIG. 2 is another exploded view of the improved food package shown in FIG. 1;

FIG. 3 is a cross-section of the improved food package of FIGS. 1 and 2 in an assembled, ready to distribute configuration having a reduced volume airspace extending between the food and a peel-off film lying in close proximity to the food;

FIG. 4 is a cross-section of a conventional food package having a relatively large volume airspace extending between the food and the usual peel-off film spaced above the food;

FIG. 5 is an elongated detail of the improved food package taken from FIG. 3; and

FIG. 6 shows a pair of food packages like the improved package that is shown in FIG. 3 standing one on top of the other in a vertical stack.

### DESCRIPTION OF THE PREFERRED EMBODIMENT

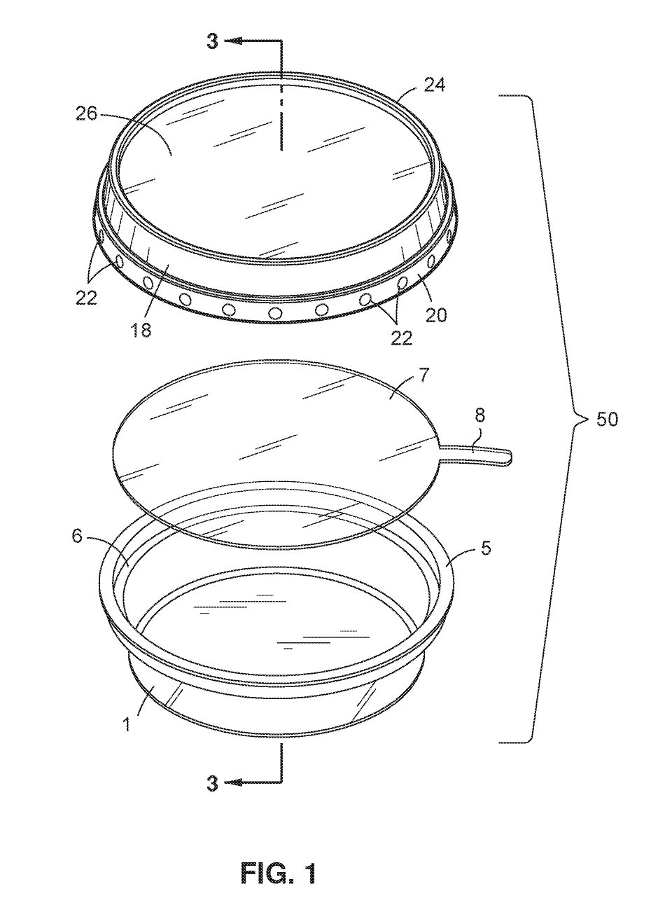

Referring initially to FIGS. 1-5 of the drawings, there is shown an improved food package 50 that includes a food bowl 1 of the kind that is capable of holding a food 3 prior to its consumption. By way of example only, the food 3 within the food bowl 1 is hummus. However, it is to be understood that other foods besides hummus can be packaged within the food bowl 1, especially those to which a topping will be added prior to consumption for the purpose of enhancing the taste of the food. In this regard, another example of a food 3 to be carried by and packaged within the food bowl 1 is yogurt.

The food bowl 1 also holds a topping 4 that is initially placed atop the food 3. The topping 4 will typically be added to and mixed with the food 3 when the food is consumed. By way of example, where hummus is the food 3 packaged within the food bowl 1, the topping 4 that is packaged within the bowl atop the hummus to be mixed into the hummus is typically a mixture of oil, pine nuts, spices, and the like. However, if yogurt were the food 3 that is packaged within the food bowl 1, the topping 4 to be placed atop and mixed into the yogurt will typically be granola and/or fruit. By way of still another example, the food 3 may be a salad and the topping 4 can be dry salad fixings. In any event, it is to be understood that the specific food 3 within the food bowl 1 and the topping 4 to be added to and mixed with the food 3 prior to their consumption are not to be considered as a limitation of this invention.

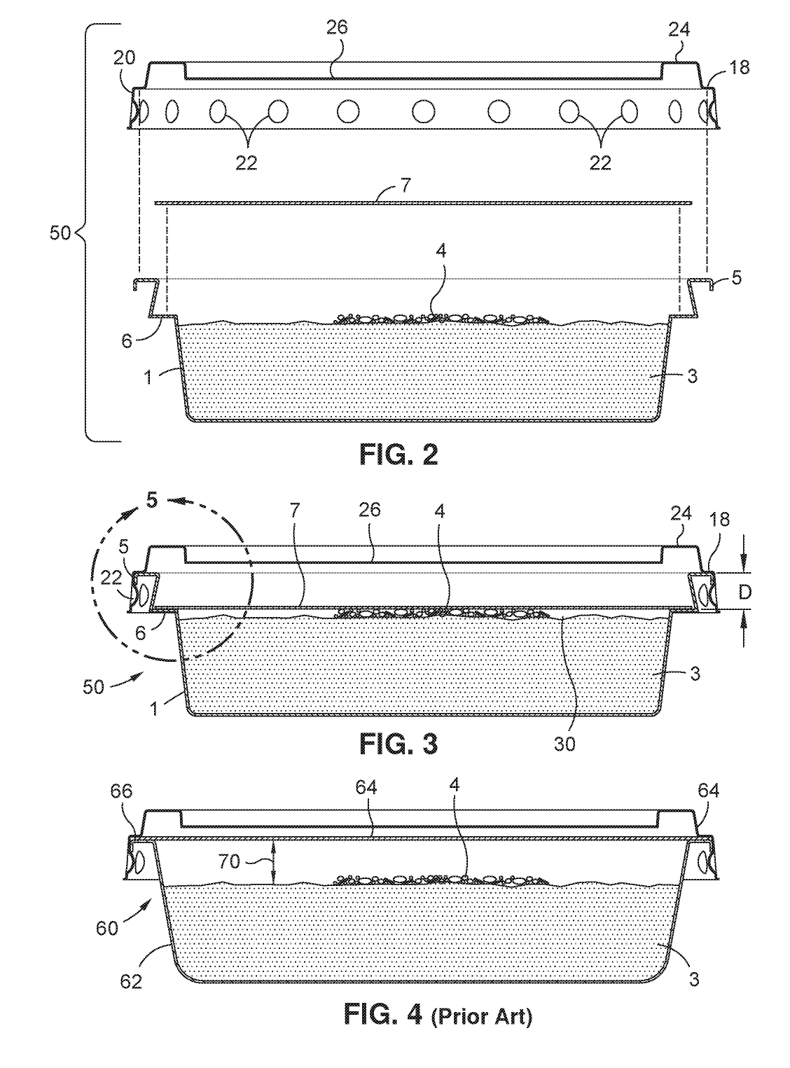

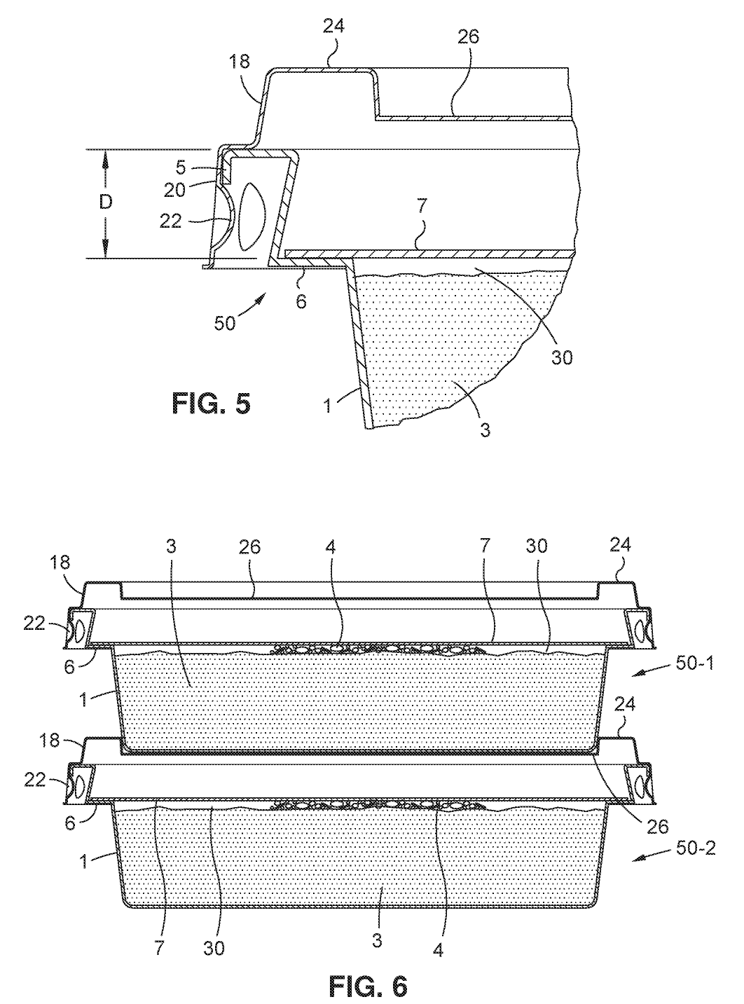

The food bowl 1 is preferably manufactured from a flexible, clear and visually transparent (e.g., plastic) material so that consumers can see the food 3 and the topping 4 that are packaged therein. The food bowl 1 has a normally open top and a peripheral lip 5 that extends outwardly from and surrounds the open top. As an important feature of this invention, a peripheral sealing ledge 6 extends radially inward from the sides of the food bowl 1 so as to be spaced downwardly from the peripheral lip 5 and lie below the open top of the food bowl 1 surrounded by the lip 5 by a distance D (best shown in FIG. 5). As is best shown in FIGS. 2 and 3, a thin peel-off film 7 is sealed against the peripheral sealing ledge 6 below the normally open top of the food bowl 1 to extend laterally across and close the bowl in order to create a fluid-tight seal and prevent the food and topping contents of the bowl from spilling out. As in the case of the sealing ledge 6, the peel-off film 7 that is sealed to the peripheral sealing ledge is spaced below the peripheral lip 5 and the normally open top of the food bowl 1 by substantially the same distance D as that shown in FIG. 5. A flexible pull tab 8 (best shown in FIG. 1) extends from the peel-off film 7 to which a pulling force is applied when it is desirable to remove the film 7 from the food bowl 1 to gain access to the food 3 and the topping 4 that are packaged therewithin.

It is contemplated that the food 3 that is packaged within the food bowl 1 and the topping 4 carried within the food bowl atop the food 3 will be subjected to a conventional high pressure processing (HPP) treatment prior to the distribution of the food package 50 to the public for consumption. In this case, it is desirable to prevent the premature mixing of the food 3 and the topping 4 as may occur due to the turbulence that is likely to be created during the HPP process when the topping 4 and the food 3 are packaged one directly above the other. Any such premature mixing of the topping 4 with the food 3 prior to their consumption can negatively affect the visual and commercial appeal of the food package 50 as well as a consumer's perception and decision to buy the food 3 that is packaged within and visible through the clear food bowl 1.

The improved food package 50 is assembled when a lid 18 having a closed top is detachably connected to the top of the food bowl 1 above the food 3 and the topping 4 therewithin. The lid 18 is ideally manufactured from a clear, visually transparent (e.g., plastic) material that is flexible. A generally cylindrical peripheral base 20 surrounds the bottom of the flexible lid 18. A set of radially inward projecting locking detents 22 are formed in and spaced from one another around the peripheral base 20 of lid 18.

As is best shown in FIGS. 3 and 5, when the lid 18 of the food package 50 is detachably connected to the top of the food bowl 1, the peripheral base 20 of lid 18 is moved into surrounding engagement with the peripheral lip 5 that surrounds the open top of the food bowl 1. The peripheral base 20 of the flexible lid 18 is initially stressed and bent outwards to be able to accommodate the peripheral lip 5 of the food bowl 1 thereunder. When the flexible lid 18 relaxes and returns to its pre-stressed shape, the inward projecting locking detents 22 that are formed in and around the peripheral base 20 of lid 18 are snapped into removable receipt against and below the peripheral lip 5 of the food bowl 1 by which the lid 18 is held in place over and across the food bowl.

The flexible lid 18 has a raised peripheral rim 24 extending therearound and standing upwardly therefrom. Located at the center of the closed top of the lid 18 so as to be surrounded by and lie below the raised peripheral rim 24 is a stacking recess 26. Referring briefly to FIG. 6 of the drawings, the raised peripheral rim 24 and the stacking recess 26 that is surrounded by the rim cooperate to enable a plurality of identical food packages (designated 50-1 and 50-2 in FIG. 6) like the improved package 50 that is shown in FIG. 3 to be nested together one above the other in a vertical stack. More particularly, the food bowl 1 of a first upper food package 50-1 is laid on top of the lid 18 of a second lower food package 50-2. The bottom of the food bowl 1 from the upper food package 50-1 is sized to be received within the peripheral rim 24 and seated on the stacking recess 26 of the lower food package 50-2. Thus, the bottom of the food bowl 1 of the upper food package 50-1 is located within and surrounded by the raised peripheral rim 24 that stands upwardly from the lid 18 of the lower package 50-2.

Accordingly, the bottom of the upper food package 50-1 is seated on the top of the lower food package 50-2 and disposed in a compact vertical stack that may include one or more additional food packages (not shown) to facilitate the shipping and/or storage of the stack and any food and topping that may be carried in the food bowls 1. The raised peripheral rims 24 within which the bottoms of the food bowls 1 are located advantageously prevent an upper food package (e.g., 50-1) from sliding off the lid 18 that sits atop a lower food package (e.g., 50-2). When needed, the upper food package 50-1 of the vertical stack may be simply lifted upwardly from and off the lower food package 50-2.

Referring specifically to FIG. 3 of the drawings, the assembled food package 50 is shown with the lid 18 detachably connected to the top of the food bowl 1. Because the peripheral sealing ledge 6 is spaced below the top of the food bowl 1 by the aforementioned distance D, the peel-off film 7 that is sealed against the sealing ledge so as to extend laterally over and cover the food 3 and topping 4 within the food bowl is likewise spaced below the top of the food bowl by substantially the identical distance D. The distance D is selected depending upon the amount of food 3 with which the food bowl 1 will be filled so that the peel-off film 7 is located in either direct contact with or in close proximity to the food 3 and its topping 4. According to a preferred embodiment, the film 7 is ideally spaced no more than 5 mm above the food 3 and the topping 4. However, regardless of its exact spacing, the peel-off film 7 is located closer to the food 3 and the topping 4 in the food bowl 1 than to the normally open top of the food bowl.

Accordingly, and as is best shown in FIG. 5, a relatively small volume airspace 30 is created within the food bowl 1 between the peel-off film 7 and the topping 4 lying on the food 3. By virtue of creating the small volume airspace 30 below the peel-off film 7 that closes the food bowl 1, the air turbulence to which the food 3 and the topping 4 are subjected when the food package 50 undergoes the HPP process will be minimized. In this case, the food 3 and topping 4 will advantageously remain separated from one another and not be mixed together until the peel-off film 7 is removed from the food bowl 1 by a consumer.

In this regard, and turning now to FIG. 4 of the drawings, a conventional food package 60 is shown having a food bowl 62 and a lid 64 detachably connected to the food bowl. The food bowl 62 of package 60 is shown holding the same food 3 and topping 4 that are packaged in the food bowl 1 of the improved food package 50 of FIG. 3. In the case of the conventional food package 60, a peel-off film 64 is sealed directly to the peripheral lip 66 that surrounds the normally open top of the food bowl 62 so as to cover the food 3 and topping 4 and thereby close the bowl.

Because the usual peel-off film 64 extends laterally across the usual food bowl 62 at the normally open top of the bowl rather than at the distance D (of FIG. 3) spaced downwardly from and below the open top of the food bowl, a relatively large volume airspace 70 is created between the peel-off film 64 and the food 3 and its topping 4. As a consequence of the large volume airspace 70, the food 3 and the topping 4 that are carried by the conventional food package 60 are more likely to be prematurely mixed together than had they otherwise been carried by the improved food package 50 shown in FIG. 3. In particular, the aforementioned advantage of locating the peel-off film 7 of the improved package 50 downwardly from the normally open top of the food bowl 1 so as to lie at the top of the small volume airspace 30 can be best achieved when the volume of the airspace 30 within the food bowl 1 is about 5%-10% of the volume of the traditionally large volume airspace 70 that runs from the food 3 to the open top surrounded by the peripheral lip 66 of the food bowl 62 of the conventional food package 60.

It may be appreciated that the overall height of the improved food package 50 and the taper of the food bowl 1 thereof as shown in FIG. 3 have not been changed relative to the height and taper of the conventional food package 60 and food bowl 62 shown in FIG. 4. Thus, the improved food package 50 having the advantages of this invention as described above may be handled by the same apparatus as that used to handle the conventional food package 60.

1. A food package comprising:
a food container in which a first food and a second food are packaged therein to be mixed together prior to their consumption, said food container having an open top, a closed bottom and opposing sides extending between the open top and the closed bottom;
a removable thin film closure extending, laterally across the food container between the opposing sides and spaced downwardly from and below the open top of said food container so as to cover the first and second foods and seal the food container to thereby prevent the first and second foods from spilling past said closure and out of the food container, said thin film closure lying closer to the first and second foods covered by said thin film closure than to the open top of said food container, and said thin film closure lying above said first and second foods such that there is an air space established therebetween within which air turbulence is created in response to said food container undergoing a high pressure processing (HPP) treatment so as to prevent said first and second foods from being mixed together as a result of the air turbulence, and
a lid detachably connected to said food container across the open top thereof so as to lie above said thin film closure and close said food container, said thin film closure lying closer to said first and second foods than to said lid.

2. The food package recited in claim 1, wherein said first food is hummus and said second food is a topping that lays on top of the hummus so as to be mixed with the hummus and consumed therewith after said removable thin film closure is first removed from said food container.

3. The food package recited in claim 2, wherein said removable thin film closure has a pull tab extending therefrom and being responsive to a pulling force applied thereto, whereby to cause said removable closure to be removed from said food container.

4. (canceled)

5. (canceled)

6. The food package recited in claim 1, wherein said lid has a peripheral base extending therearound and a set of locking detents formed in said peripheral base, and the open top of said food container has a peripheral lip extending therearound, the set of locking detents from the peripheral base of said lid being located under and engaged by the peripheral lip of said food container when said lid is detachably connected to said food container, and said thin film closure that extends laterally across said food container being spaced downward from and below the peripheral lip that extends around the open top of said food container.

7. The food package recited in claim 1, wherein there is a sealing ledge located inside said food container and spaced downwardly from and below the open top thereof and lying above the first and second foods packaged therein, said removable thin film closure being attached to said sealing ledge and extending laterally across said food container between said opposing sides thereof downwardly from and below the open top of said food container.

8. The food package recited in claim 7, wherein said sealing ledge extends around the periphery of said food container so as to extend inwardly from the opposing sides of said food container, said removable closure being attached to said sealing ledge and extending laterally across said food container downwardly from and below the open top thereof.

9. (canceled)

10. The food package recited in claim 1, wherein the volume of said airspace lying between said removable thin film closure that extends laterally across said food container downwardly from and below the open top thereof and the first and second foods covered by said removable thin film closure is 5% to 10% of the volume of said food container extending between said open top thereof and one of the first or second foods packaged within said food container.

11. A food package comprising:
a food container in which at least one food is packaged, said food container having an open top, a closed bottom, and opposing sides extending between the open top and, the closed bottom;
a sealing ledge extending inwardly from the opposing sides of said food container at a location spaced downwardly from and below the open top thereof;
a removable thin film closure sealed against said sealing ledge and extending laterally across the food container at a location spaced downwardly from and below the open top of said food container so as to lie closer to the at least one food packaged within the food container than to the open top of the food container at which to cover the at least one food and close the food container to thereby prevent said one food from spilling past said closure and out of said food container, wherein an air space is established between said thin film closure and the at least one food; and
a lid detachably connected to said food container across the open top thereof to lie above said thin film closure and close said food container, said thin film closure lying closer to the at least one food that to said lid.

12. The food package recited in claim 11, wherein the lid that is detachably connected to said food container across the open top thereof has a peripheral lip standing upwardly therefrom and a recessed stacking area surrounded by and lying below said peripheral lip.
